(19) United States
(12) Patent Application Publication
(10) Pub. No.: US 2020/0133245 A1
(43) Pub. Date: Apr. 30, 2020

(54) Device For Coordinated Movement And/Or Orientation Of A Tracking Tool, Method For Smoothing A Part Using Said Device And Smoothing Station For Implementing Said Method

(71) Applicant: Airbus Operations S.A.S., Toulouse (FR)

(72) Inventors: Yann-Henri Laudrain, Toulouse (FR); Sébastien Martin, Toulouse (FR)

(73) Assignee: Airbus Operations S.A.S., Toulouse (FR)

(21) Appl. No.: 16/599,263

(22) Filed: Oct. 11, 2019

(30) Foreign Application Priority Data
Oct. 31, 2018 (FR) 18 60063

(51) Int. Cl. G05B 19/418; B25J 15/00; B25J 9/16; B21D 26/021; B21D 1/06; B21D 43/00

(52) U.S. Cl. CPC G05B 19/41815; B25J 15/0019; B25J 9/1697; B25J 11/0065; B21D 1/06; B21D 43/003; B21D 26/021

(57) ABSTRACT

A device for coordinated movement and/or orientation of a tracking tool relative to a portable tool handled by an operator on a production station allows a tracking tool to track the movements of a portable tool handled by an operator, without the intervention of an additional operator. Also described is a smoothing method using the device, as well as a smoothing station for implementing the method.

### FIELD OF THE INVENTION

The present application relates to a device for coordinated movement and/or orientation of a tracking tool, to a method for smoothing a part using said device, as well as to a smoothing station for implementing said method.

### BACKGROUND OF THE INVENTION

For some portable tools, such as a smoothing tool, for example, it is necessary, in addition to the main smoothing function, for a complementary suction function to be simultaneously performed in order to limit the propagation of dust.

According to a first solution, a portable tool can be equipped with a suction accessory for performing the complementary suction function. This solution is not completely satisfactory since it makes the portable tool unwieldy and heavier, which tends to increase the burden of the smoothing operation.

According to a second solution, the complementary suction function is performed by a complementary portable tool separate from the portable tool. According to this second solution, the portable tool is handled by a first operator and the complementary portable tool is handled by a second operator. This solution is not satisfactory since it requires two operators, which tends to increase the production cost.

### BRIEF SUMMARY OF THE INVENTION

Aspects of the present invention may overcome all or some of the disadvantages of the prior art.

An embodiment of the invention is a device for coordinated movement and/or orientation of a tracking tool relative to a portable tool handled by an operator on a production station, characterized in that the device for coordinated movement and/or orientation comprises a system for moving and/or orienting the tracking tool, at least one location system configured to determine information relating to at least one position and/or to at least one movement of the portable tool and at least one command unit configured to control the movement and/or orientation system, on the basis of the information determined by the location system, so as to move the tracking tool in a coordinated manner with the portable tool.

Advantageously, the portable tool is handled by the operator on the production station to perform a first task, called main task. The tracking tool is used to perform a second task, called auxiliary task, complementing the first task.

The device according to an embodiment of the invention allows a tracking tool to track the movements of a portable tool handled by an operator without the intervention of an additional operator. Since the tracking tool is separate from the portable tool, it does not affect the handling thereof. The operator can thus concentrate on the completion of the main task using the portable tool. The auxiliary task, complementing the main task, is implemented by means of the tracking tool, which is automatically moved by the device according to an embodiment of the invention. The device according to an embodiment of the invention allows the tracking tool to be moved in a coordinated manner with the portable tool, as close as possible to the portable tool.

According to a first embodiment, the location system comprises at least one camera configured to capture images of the portable tool. In addition, the command unit comprises image processing configured to analyze the images captured by the one or more cameras and to control, as a function of this analysis, the movements of the system for moving and/or orienting the tracking tool.

According to one configuration, the location system comprises a plurality of cameras fixed on a fixed point of the production station and/or on the system for moving and/or orienting the tracking tool and/or on the operator.

According to a second embodiment, the location system comprises a plurality of tags fixed on the portable tool, as well as a plurality of tag readers fixed on different fixed points of the production station and each configured to transmit a signal as a function of the position of the tags. In addition, the command unit is configured to control the movements of the system for moving and/or orienting the tracking tool on the basis of the signals transmitted by the tag readers.

According to one configuration, the tags are RFID type tags.

According to another feature, the movement and/or orientation system comprises a robotic arm supporting the tracking tool, an arm support, to which the robotic arm is connected, as well as a rail, along which the arm support moves.

Another aspect of the invention is a method for smoothing a part using a device for coordinated movement and/or orientation according to any of the preceding features.

According to one feature, the method for smoothing a part comprises:

a step of scanning the part intended to gather a set of measurements for establishing dimensions and a geometry of the part;

a step of obtaining a map of faults by comparing the measured values relating to the dimensions and to the geometry of the part with theoretical values relating to the dimensions and to a geometry of a theoretical part;

a step of smoothing for correcting the faults on the map.

According to another feature, the map of faults comprises colour gradients as a function of the differences between the measured values and the theoretical values.

According to another feature, an augmented reality viewing system is used during the smoothing step to view the map of faults so that it is superimposed on the part.

According to another feature, the map of faults is modified during smoothing in order to take into account rectifications that have already been performed.

Yet another aspect of the invention is a smoothing station for implementing the smoothing method according to any of the preceding features, characterized in that it comprises:

tooling for holding the part enabling the part to be fixedly held in at least one desired position;

a measuring system configured to measure values relating to dimensions and to a geometry of the part;

a control unit configured to compare the measured values relating to the dimensions and to the geometry of the part with theoretical values relating to dimensions and to a geometry of a theoretical part in order to establish a map of faults;

a portable smoothing tool; and

a device for coordinated movement and/or orientation of a tracking tool relative to the portable tool.

### BRIEF DESCRIPTION OF THE DRAWINGS

Further features and advantages will become apparent from the following description, which is provided solely by way of an example, with reference to the accompanying drawings, in which:

FIG. 1 is a perspective view of a smoothing station equipped with a device for coordinated movement and/or orientation of a tracking tool, which figure shows an embodiment of the invention during a step of positioning a part;

FIG. 2 is a perspective view of the smoothing station shown in FIG. 1 during a step of scanning the part;

FIG. 3 is a perspective view of the smoothing station shown in FIG. 1 during a step of setting up the station;

FIG. 4 is a perspective view of the smoothing station shown in FIG. 1 during a step of viewing faults in the part;

FIG. 5 is a perspective view of a portable tool handled by an operator and of a tracking tool at the start of a step of smoothing the part;

FIG. 6 is a perspective view of the portable tool and of the tracking tool shown in FIG. 5 during the step of smoothing the part;

FIG. 7 is a perspective view of the portable tool and of the tracking tool shown in FIG. 5 at the end of the step of smoothing the part;

FIG. 8 is a perspective view of the smoothing station shown in FIG. 1 during a step of inspecting the part; and

FIG. 9 is a schematic representation of a device for moving a tracking tool that shows an embodiment of the invention.

### DETAILED DESCRIPTION

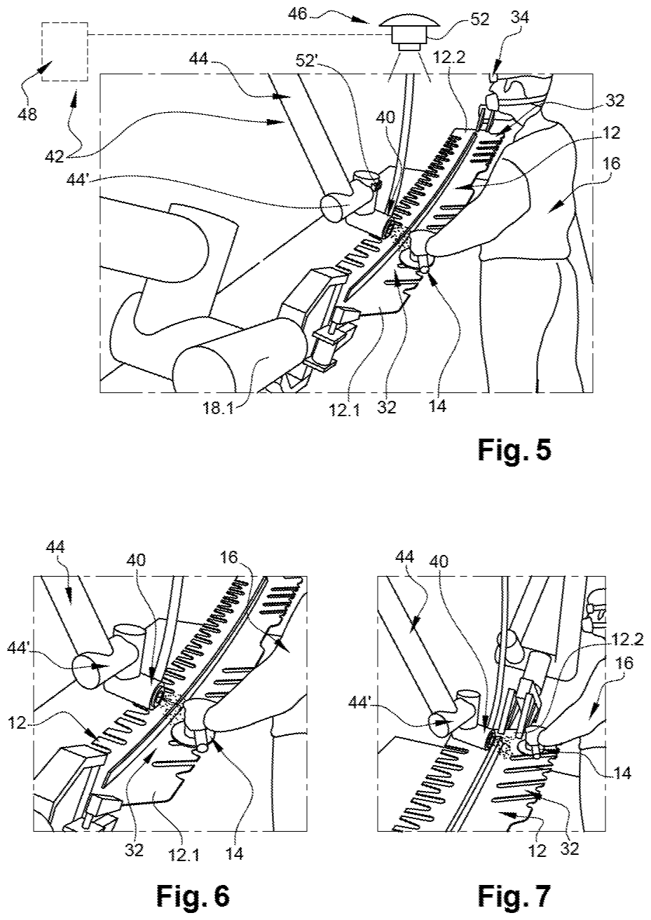

FIGS. 1 to 4 and 8 show a smoothing station 10, on which a part 12 is smoothed using a portable smoothing tool 14 (shown in FIGS. 5 to 7), such as a grinder, for example, handled by an operator 16.

According to one application, the part 12 comprises first and second ends 12.1, 12.2 and has a T-shaped section, is very long and has a curved profile from one end to the next. By way of an example, the part 12 is a connection part of a central wing box of an aircraft.

The smoothing station 10 comprises tooling 18 for holding the part 12 allowing the part to be fixedly held in at least one desired position. According to one embodiment, the handling tooling 18 comprises first and second grippers 18.1, 18.2 configured to grasp the first and second ends 12.1, 12.2 of the part 12.

According to a configuration shown in FIG. 1, the step of positioning the part 12 on the handling tooling 18 is automated. To this end, a movable platform 20 is provided to route the part 12 on the smoothing station 10 between the first and second grippers 18.1, 18.2. In addition, the smoothing station 10 comprises at least one detection system 22 configured to detect the movable platform 20 and to locate the part 12, as well as a control unit 24 configured to control the first and second grippers 18.1, 18.2, on the basis of the data supplied by the detection system 22, so that said grippers respectively grasp the first and second ends 12.1, 12.2 of the part 12 and position the part 12 in the desired position.

According to one embodiment, each gripper 18.1, 18.2 is a robotic arm with an anthropomorphic architecture.

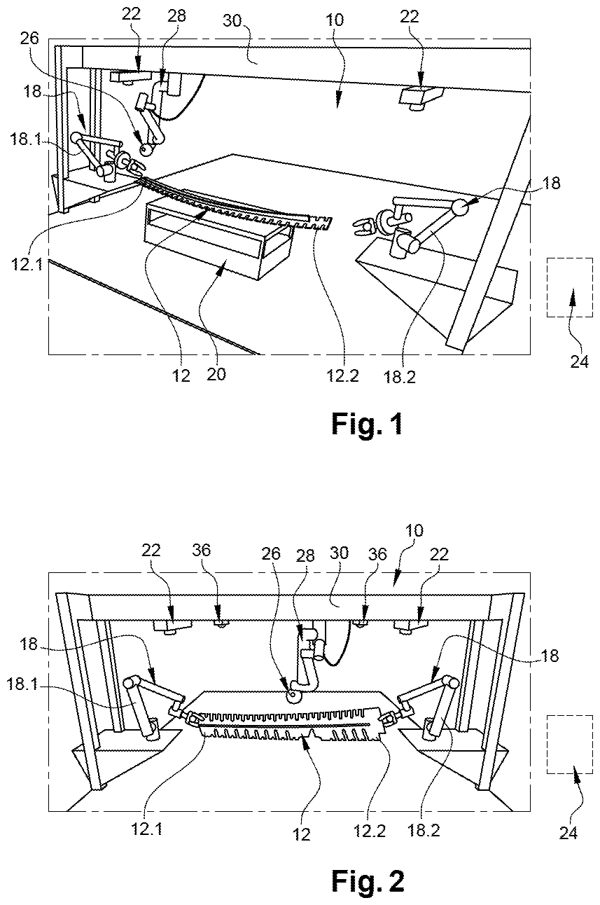

The smoothing station 10 comprises a measuring system 26 configured to determine the dimensions and the geometry of the part 12. Thus, during a step of scanning the part, shown in FIG. 2, the measuring system 26 moves along the part 12. According to one configuration, the measuring system 26 is supported by a robotic arm 28, which moves along a rail 30 provided above the part 12. The control unit 24 controls the measuring system 26 and the robotic arm 28 so that the measuring system 26 scans the part 12 and gathers a set of measurements for establishing the dimensions and the geometry of the part 12, as well as a virtual representation of the part 12.

The control unit 24 comprises a spatial swinging algorithm for comparing the measured values relating to the dimensions and to the geometry of the part 12 with theoretical values relating to the dimensions and to the geometry of a theoretical part, in order to determine at least one zone 32 to be rectified, shown in FIG. 4. The control unit 24 defines, on the basis of the comparison of the measured values and of the theoretical values, a map of faults using colour gradients as a function of the differences between the measured values and the theoretical values, as shown in FIG. 4.

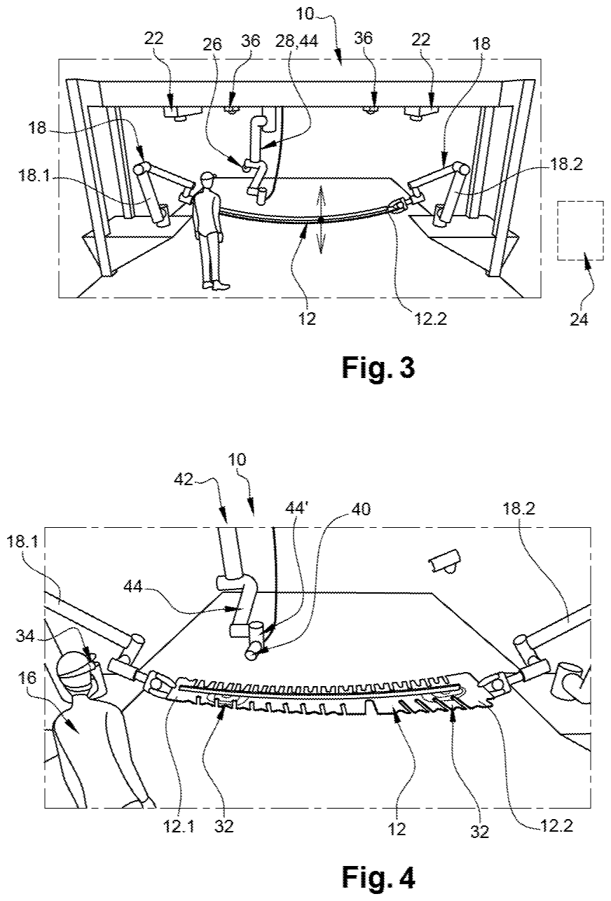

During an adjustment step shown in FIG. 3, the part 12 is suitably positioned, by virtue of the first and second grippers 18.1, 18.2, for the optimal comfort and the highest safety of the operator 16 performing the operation of smoothing the part 12.

The smoothing station 10 comprises an augmented reality viewing system 34, worn by the operator 16, configured to allow them to view, superimposed on the part 12, the map of faults with the colour gradients.

In a particular embodiment, the smoothing station 10 comprises a set of cameras 36 configured to film the part 12 in real-time during smoothing. The control unit 24 comprises image processing configured to analyze the images captured by the set of cameras 36. In addition, the control unit 24 is configured to modify, during smoothing, the map of faults and the colour gradients on the basis of the analysis of the images captured by the set of cameras 36, in order to take into account rectifications already performed by the operator 16.

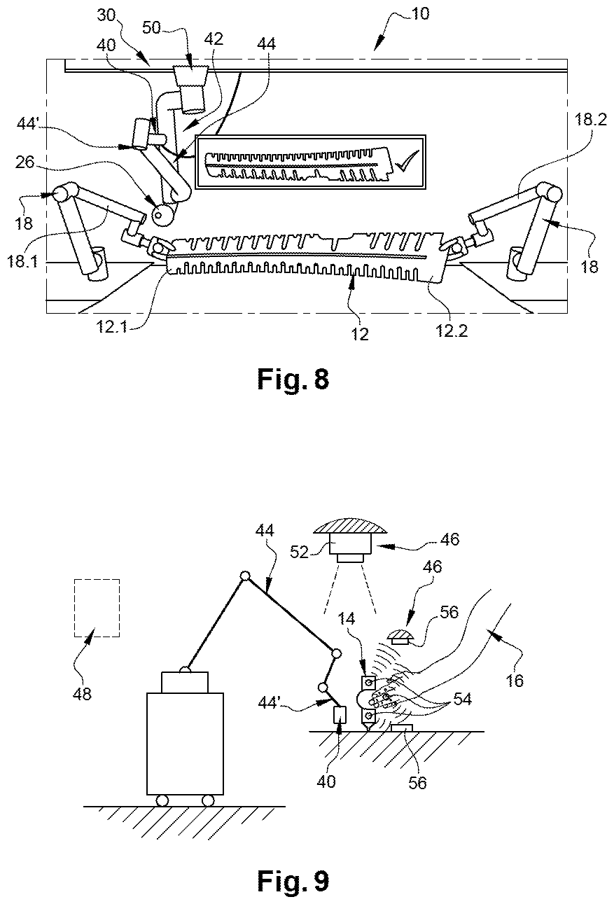

When the smoothing operation is complete, and during a visual inspection step shown in FIG. 8, the measuring system 26 is moved along the part 12 in order to take a new series of measurements. The values of these new measurements are compared to the theoretical values in order to establish a new map of the faults. If the faults are within the tolerance ranges, then the part 12 is declared compliant. Otherwise, if the part 12 is not compliant, the operator 16 can continue smoothing using the augmented reality viewing system 34.

When the part 12 is compliant, it is automatically removed using a movable platform, as in the step of positioning the part 12 shown in FIG. 2.

According to another feature, the fault related data is gathered in a database in order to check whether some of these faults are recurrent on most of the parts. In this case, the method for manufacturing the part 12 can be corrected in order to correct these recurrent faults.

As shown in FIGS. 5 to 7, during the smoothing operation the operator 16 handles a portable tool 14. This smoothing operation corresponds to a main task, which must be performed on the smoothing station. In order to limit the propagation of dust, the smoothing station 10 comprises a suction tool, hereafter called tracking tool 40, as well as a device 42 for coordinated movement and/or orientation, to which device the tracking tool 40 is fixed. Dust suction corresponds to an auxiliary task, complementing the main smoothing task.

According to one embodiment, the device 42 for coordinated movement and/or orientation comprises a robotic arm 44 with an anthropomorphic architecture, as well as an effector 44′ supported by the robotic arm 44 and to which the tracking tool 40 is connected.

According to a configuration shown in FIG. 2, for example, the tracking tool 40 and the measuring system 26 are connected to the same robotic arm 28, 44.

The device 42 for coordinated movement and/or orientation comprises at least one location system 46, which is configured to determine information relating to at least one position and/or to at least one movement of the portable tool 14 handled by the operator 16, and at least one command unit 48, which is configured to control, on the basis of the information determined by the location system 46, the robotic arm 44 and the effector 44′ in order to move the tracking tool 40 in a coordinated manner with the movement of the portable tool 14.

Thus, the device 42 for coordinated movement and/or orientation allows the tracking tool to move without previously programming the movements of said tracking tool.

According to one embodiment, shown in FIG. 8, the device 42 for coordinated movement and/or orientation comprises an arm support 50, to which the robotic arm 44 is connected, as well as a rail, provided above the part 12, along which rail the arm support 50 moves. According to this embodiment, the command unit 48 is configured to control, on the basis of the information determined by the location system 46, the robotic arm 44, the effector 44′ and the arm support 50 in order to move the tracking tool 40 in a coordinated manner with the movement of the portable tool 14. The fact that the robotic arm 44 moves along a rail means that the behaviour of the tracking tool 40 can be managed as close as possible to the portable tool 14, which maximizes the workspace by moving the various segments of the robotic arm 44 away from the operator. The command unit 48 controls the robotic arm 44 and the arm support 50 in accordance with a multi-constraint reactive control.

Of course, the invention is not limited to this embodiment. Thus, the robotic arm 44, the effector 44′ and the optional arm support 50 could be replaced by any system for moving and/or orienting the tracking tool 40 in a given coordinate system, in which the portable tool 14 to be tracked moves.

Irrespective of the embodiment, the movement and/or orientation system comprises a plurality of segments and of joints connecting the tracking tool 40 to an element of the smoothing station 10. According to one operating mode, during the movement of the tracking tool 40 in a coordinated manner relative to the movement of the portable tool 14, the command unit 48 favours the movement of the segments and of the joints closest to the tracking tool 40 in order to obtain precise movements.

According to a first embodiment, shown in FIG. 5, the location system 46 comprises at least one camera 52, 52′ configured to capture images of the portable tool 14 and optionally of the operator 16. In addition, the command unit 48 comprises image processing configured to analyze the images captured by the one or more cameras 52, 52′ and to control, as a function of this analysis, the movements of the movement and/or orientation system for moving the tracking tool 40 in a coordinated manner with the movement of the portable tool 14.

According to a first configuration, the camera 52 is secured to a fixed point of the smoothing station 10, which allows an absolute location of the portable tool 14 in the smoothing station to be obtained.

According to another configuration, the camera 52′ is fixed to the robotic arm 44, which allows a relative location of the portable tool 14 relative to the robotic arm 44 to be obtained.

According to another configuration, the camera could be fixed on the operator 16.

The location system 46 can comprise a single camera 52, 52′ or a plurality of cameras 52, 52′ fixed on a fixed point of the smoothing station 10 and/or on the system for moving and/or orienting the tracking tool 40 and/or on the operator 16.

According to another embodiment, shown in FIG. 9, the location system 46 comprises a plurality of RFID type tags 54 fixed on the portable tool 14 and optionally on the operator 16, as well as a plurality of tag readers 56 fixed on different fixed points of the smoothing station 10 and each configured to transmit a signal as a function of the position of the tags 54 relative to the tag reader 56. In this case, the command unit 48 is configured to control, on the basis of the signals transmitted by the tag readers 56, the movements of the movement and/or orientation system in order to move the tracking tool 40 in a coordinated manner with the movement of the portable tool 14.

The two embodiments of the location system 46 can be combined on the same smoothing station.

Even though they are described as separate, the command unit 48 and the control unit 24 could be the same unit.

Of course, the invention is not limited to smoothing and to a portable smoothing tool. It can be used for any material removal operation. Thus, as shown in FIG. 9, the portable tool 14 could be a drilling tool and the tracking tool could be a swarf removal tool. Thus, the invention can be used to allow any tracking tool 40 to move in a coordinated manner with a portable tool 14 handled by an operator 16 on a production station.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A device for coordinated movement and/or orientation of a tracking tool relative to a portable tool handled by an operator on a production station for performing a first task, called main task, wherein the device for coordinated movement and/or orientation comprises:
a system for moving and/or orienting the tracking tool;
at least one location system configured to determine information relating to at least one position and/or to at least one movement of the portable tool; and
at least one command unit configured to control the movement and/or orientation system, on the basis of the information determined by the location system, so as to move the tracking tool in a coordinated manner with the portable tool to perform a second task, called auxiliary task, complementing the main task.

2. The device for coordinated movement and/or orientation according to claim 1, wherein the location system comprises at least one camera configured to capture images of the portable tool, and
wherein the command unit comprises image processing configured to analyze the images captured by the one or more cameras and to control, as a function of the analysis, the movements of the system for moving and/or orienting the tracking tool.

3. The device for coordinated movement and/or orientation according to claim 2, wherein the at least one camera comprises a plurality of cameras fixed on a fixed point of the production station and/or on the system for moving and/or orienting the tracking tool and/or on the operator.

4. The device for coordinated movement and/or orientation according to claim 1, wherein the location system comprises a plurality of tags fixed on the portable tool, as well as a plurality of tag readers fixed on different fixed points of the production station and each configured to transmit a signal as a function of the position of the tags, and
Wherein the command unit is configured to control the movements of the system for moving and/or orienting the tracking tool on the basis of the signals transmitted by the tag readers.

5. The device for coordinated movement and/or orientation according to claim 4, wherein the tags are RFID type tags.

6. The device for coordinated movement and/or orientation according to claim 1, wherein the movement and/or orientation system comprises a robotic arm supporting the tracking tool, an arm support, to which the robotic arm is connected, as well as a rail, along which the arm support moves.

7. A method for smoothing a part using a portable smoothing tool handled by an operator, using a suction tool connected to a device for coordinated movement and/or orientation according to claim 1, to allow the suction tool to move in a coordinated manner with the portable smoothing tool, the method comprising:
scanning the part intended to gather a set of measurements for establishing dimensions and a geometry of the part;
obtaining a map of faults by comparing the measured values relating to the dimensions and to the geometry of the part with theoretical values relating to the dimensions and to a geometry of a theoretical part; and
smoothing for correcting the faults on the map.

8. The method for smoothing a part according to claim 7, wherein the map of faults comprises colour gradients as a function of the differences between the measured values and the theoretical values.

9. The method for smoothing a part according to claim 7, wherein an augmented reality viewing system is used during the smoothing step to view the map of faults so that the map of faults is superimposed on the part.

10. The smoothing method according to claim 7, wherein the map of faults is modified during smoothing to take into account rectifications that have already been performed.

11. A smoothing station for implementing the smoothing method according to claim 7, further comprising:
tooling for holding the part enabling the part to be fixedly held in at least one desired position;
a measuring system configured to measure values relating to dimensions and to a geometry of the part;
a control unit configured to compare the measured values relating to the dimensions and to the geometry of the part with theoretical values relating to dimensions and to a geometry of a theoretical part in order to establish a map of faults;
a portable smoothing tool; and
a device for coordinated movement and/or orientation of a tracking tool relative to the portable tool according to claim 1.
